(19) United States
(12) Patent Application Publication
(10) Pub. No.: US 2014/0291367 A1
(43) Pub. Date: Oct. 2, 2014

(54) SADDLEBAG REMOVAL ASSEMBLY AND SYSTEM

(71) Applicant: Rich Colano, Burlington, WI (US)

(72) Inventor: Rich Colano, Burlington, WI (US)

(21) Appl. No.: 13/853,597

(22) Filed: Mar. 29, 2013

(51) Int. Cl. B62J 9/00

(52) U.S. Cl. CPC B62J 9/00
USPC 224/413

(57) ABSTRACT

A saddlebag removal system and a saddlebag attachment assembly comprise a fastener assembly with a fastening member comprising a base portion and an axially extending central portion adjacent to the base portion. A securing member surrounds the central portion and contacts the central portion in an interference fit. A tether member comprises a first end coupled to the fastener assembly and a second end coupled to an anchoring surface and is configured to structurally connect the fastening member and the anchoring surface. Additionally, a plurality of pads may be coupled to a lower surface of the saddlebag to prevent contact between the lower surface and a surface upon which the saddlebag rests.

### FIELD OF THE INVENTION

This invention is directed generally to saddlebag assemblies and, more particularly, to a saddlebag removal system and a saddlebag attachment assembly having pads for saddlebag lower surface protection and fastener retaining features for retaining a structural connection between fastener assembly parts and an anchoring surface.

### BACKGROUND OF THE INVENTION

Vehicles such as motorcycles frequently utilize containers known as saddlebags that are coupled to the vehicle frame or body in order to store and/or transport items. It is advantageous for a vehicle operator or owner to have the ability to remove a saddlebag for a variety of reasons, including cold weather storage of the vehicle, during cleaning or overhaul of vehicle components, or in the event that an operator wishes to operate the vehicle without a saddlebag attached to the vehicle. Many saddlebags feature a top portion that opens to allow access to the contents of the saddlebag. Once the top portion of the saddlebag is open, an interior surface of the saddlebag that is adjacent to the frame of the vehicle is accessible. The interior surface may be used for coupling the saddlebag to the frame of the vehicle. However, a fastener assembly having multiple separate parts or requiring a separate tool to fasten the saddlebag to the vehicle frame will significantly increase the amount of time required for removal and mounting. Additionally, a fastener assembly with separate parts increases the likelihood that one or more parts of the assembly, or the entire fastener assembly, will be separated from the saddlebag and dropped or misplaced, thereby preventing, impeding, or delaying the secure attachment of the saddlebag to the vehicle.

### SUMMARY OF THE INVENTION

In accordance with an aspect of the invention, a saddlebag attachment assembly is provided comprising a fastening member having a base portion and an axially extending central portion coupled to the base portion. A securing member surrounds the central portion and contacts the central portion in an interference fit. The saddlebag attachment assembly includes a tether member comprising a first end coupled to the base portion and a second end coupled to an anchoring surface. The tether member is configured to structurally connect the fastening member and the anchoring surface.

In accordance with further aspects of the invention, the securing member may be annular. Additionally, the securing member may be composed of a polymer or elastomer material. The saddlebag attachment assembly may further comprise a plate member surrounding the central portion and disposed between the base portion and the securing member, wherein the plate member may be annular. The fastening member may further comprise an attachment portion coupled to the base portion, the tether member being coupled to the base portion via the attachment portion. The attachment portion may comprise an annular structure, the tether member being coupled to the attachment portion via the annular structure. The anchoring surface may be configured to be coupled to a vehicle such as a motorcycle having a saddlebag, which may comprise the anchoring surface. The saddlebag may further comprise a plurality of pads configured to couple to a lower surface of the saddlebag to prevent contact between the lower surface and a surface upon which the saddlebag rests. Finally, the fastening member may be configured to fasten by rotation of the fastening member about a longitudinal axis of the fastening member.

In accordance with another aspect of the invention, a saddlebag removal system is provided comprising a securing member configured to surround a central portion of a stud member and contact the stud member in an interference fit. The saddlebag removal system includes a tether member configured to flexibly couple the stud member to an anchoring surface. The securing member and the tethering member cooperate to maintain a structural connection between all parts of a fastening assembly.

In accordance with still further aspects of the invention, the anchoring surface may be configured to surround the stud member upon fastening. The securing member may be annular and may be composed of polymer or elastomer material. The tether member may comprise a cable or wire. The fastening assembly may be configured to fasten by rotation of the stud member about a longitudinal axis of the stud member. Additionally, the securing member may be configured to be disposed adjacent to a plate member surrounding the central portion in a non-interference fit relationship. The plate member may be disposed between the tether member and the securing member. Finally, the anchoring surface may form one portion of a container coupled to a vehicle, such as a motorcycle saddlebag. The saddlebag may comprise a plurality of pads configured to couple to a lower surface of the saddlebag to prevent contact between the lower surface and a surface upon which the saddlebag rests.

### BRIEF DESCRIPTION OF THE DRAWINGS

While the specification concludes with claims particularly pointing out and distinctly claiming the present invention, the present invention will be better understood from the following description in conjunction with the accompanying Drawing Figures, in which like reference numerals identify like elements, and wherein:

FIG. 1 is a perspective view of a saddlebag according to aspects of the present invention;

FIG. 2 is an enlarged cross sectional view of a saddlebag attachment assembly according to aspects of the present invention; and

FIG. 3 is an enlarged perspective view of a saddlebag attachment assembly according to aspects of the present invention.

FIG. 4 is an enlarged perspective view of a saddlebag attachment assembly according to further aspects of the present invention.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

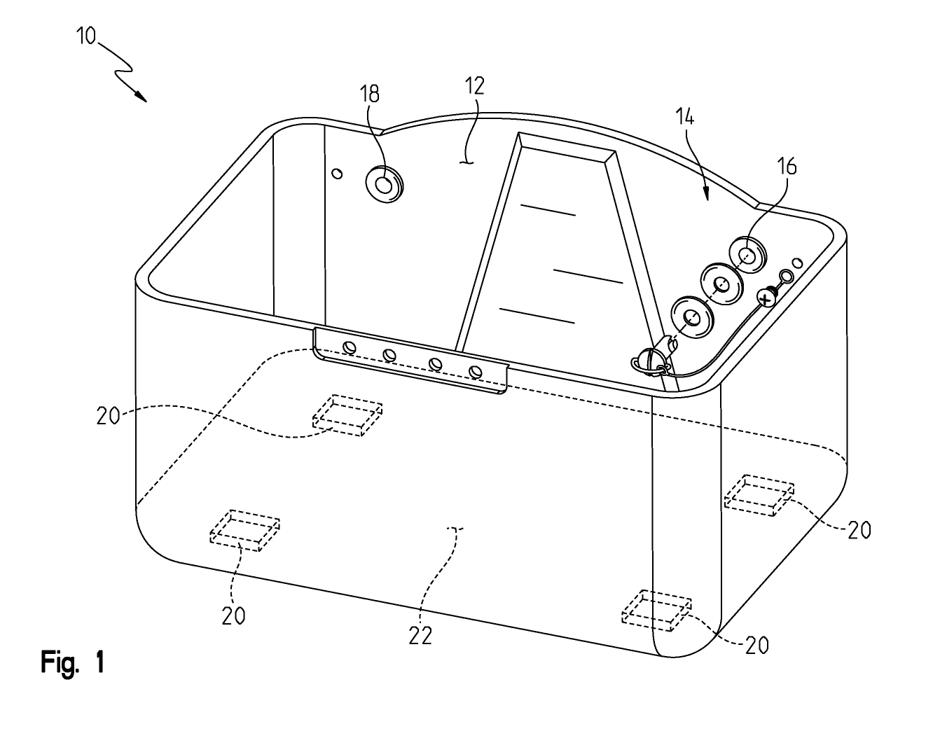

Reference is now made to FIG. 1 which shows a saddlebag attachment assembly according to aspects of the present invention. Saddlebag 10 is mounted to a vehicle such as a motorcycle for the purpose of carrying or storing items with the vehicle. In a preferred embodiment of the present invention, two saddlebags may be attached, one on each side of a motorcycle toward the rear end of the vehicle. Although not shown in FIG. 1, the saddlebag 10 of the preferred embodiment of the present invention may include a top portion to enclose the saddlebag, thereby preventing any loss or introduction of items while operating the vehicle. The top portion of the saddlebag 10 may open to allow access to the interior of the saddlebag 10. As shown in FIG. 1, the saddlebag 10 of the preferred embodiment includes an interior surface 12 that is adjacent to the frame of the vehicle. The interior surface 12 may be used for coupling the saddlebag 10 to the frame of the vehicle, as discussed below. Although the saddlebag 10 of the preferred embodiment of the present invention is made of a rigid material such as a hard plastic or fiberglass, the saddlebag 10 may be made of a soft or flexible material such as a flexible polymer, elastomer, or leather.

Referring again to FIG. 1, the interior surface 12 is coupled to the vehicle with a saddlebag fastener assembly 14. In the preferred embodiment of the present invention, the saddlebag fastener assembly 14 couples the saddlebag 10 to the vehicle through an interior surface opening 16 of the saddlebag 10. Additionally, the preferred embodiment includes a second interior surface opening 18 to permit a second point of coupling between the saddlebag 10 and the vehicle using a second fastener assembly (not shown) in order to strengthen and stabilize the mounting of the saddlebag 10 to the vehicle.

When the saddlebag 10 of the preferred embodiment is detached from a vehicle for reasons such as off-season storage or cleaning of the vehicle or saddlebag, the saddlebag may rest on the ground or another surface. Referring again to FIG. 1, a preferred embodiment of the present invention includes bumper pads 20 attached to a saddlebag lower surface 22 that faces in the downward direction. In the preferred embodiment, the bumper pads 20 are attached to the lower surface 22 with adhesive, but may be attached using other means such as a separate fastener. Because saddlebags often feature attractive paint and exterior surface finishes, the bumper pads 20 prevent an abrasive surface, such as a concrete floor, from damaging the lower surface 22 while being small enough not to add significant additional weight or visual interference.

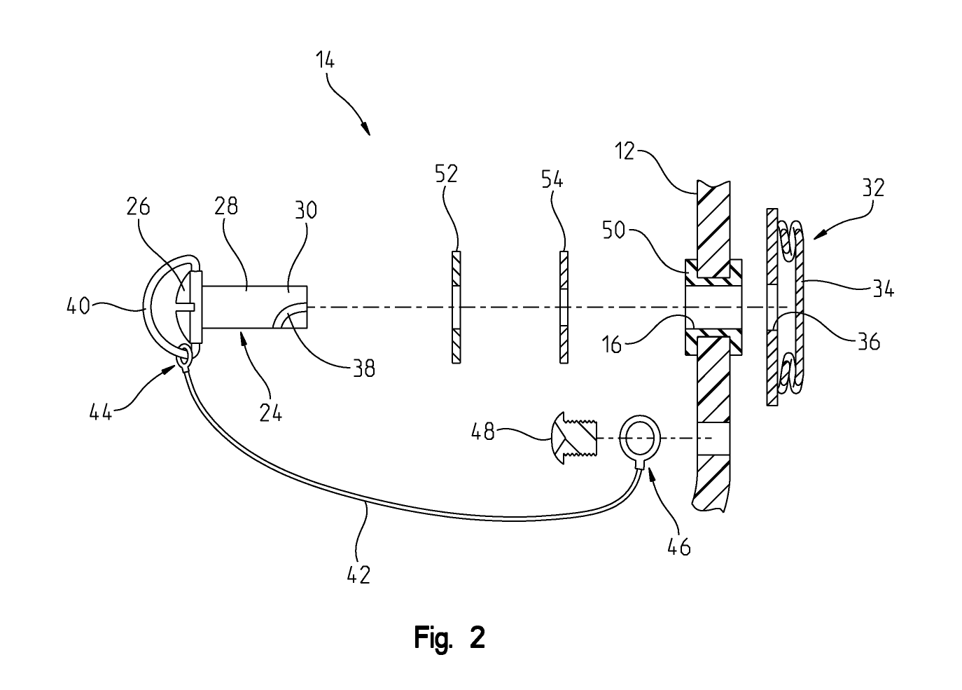

Referring now to FIG. 2, a partial-exploded view of the saddlebag fastener assembly 14 of the preferred embodiment of the present invention is shown. A fastening member 24 has a base portion 26 and a central portion 28 that extends in an axial direction away from the base portion 26. At the end of the central portion 28 distal to the base portion 26, a locking portion 30 is structured to allow fastening of the fastening member 24 to a spring plate 32. The spring plate 32 contains a wire 34 disposed over a spring plate opening 36. Once the locking portion 30 of the fastening member 24 passes through the interior surface opening 16 of the saddlebag 10 and the locking portion 30 engages the wire 34 of the spring plate 32, the wire 34, remaining substantially stationary, may enter an internal channel 38 of the locking portion 30 as the fastening member 24 is rotated about its longitudinal axis. After the fastening member 24 rotates about 90 degrees, further rotation is prevented by the internal channel 38, and the fastener assembly 14 is securely coupled to the spring plate 32 to prevent axial movement. In the preferred embodiment, spring plate 32 is rigidly attached to a vehicle such that the fastener assembly 14 may be securely coupled to the vehicle once the fastening member 24 is locked to the spring plate 32. The interior surface opening 16 of the preferred embodiment may also include a grommet 50 to resiliently couple the saddlebag 10 and the spring plate 32 to the fastener assembly 14.

Referring again to FIG. 2, the fastening member 24 additionally includes an attachment portion 40 coupled to the base portion 26. The attachment portion 40 is preferably an annular structure, such as a metal ring or loop, and its connection to the base portion 26 may allow pivoting between the two structures.

As can be seen in FIG. 2, a tether member 42 structurally connects the fastening member 24 to the interior surface 12. In order to prevent disconnection and subsequent loss of the fastening member 24, interior surface 12 acts as an anchoring surface for the fastening member 24. A first end 44 of the tether member 42 is preferably attached to the attachment portion 40 of the fastening member 24 and a second end 46 is preferably attached to the interior surface 12 using a separate fastener 48. In the preferred embodiment, tether member 42 is a wire, but any means capable of structurally connecting the fastening member 24 to the interior surface 12, such as a string, cable or chain, is included in the present invention.

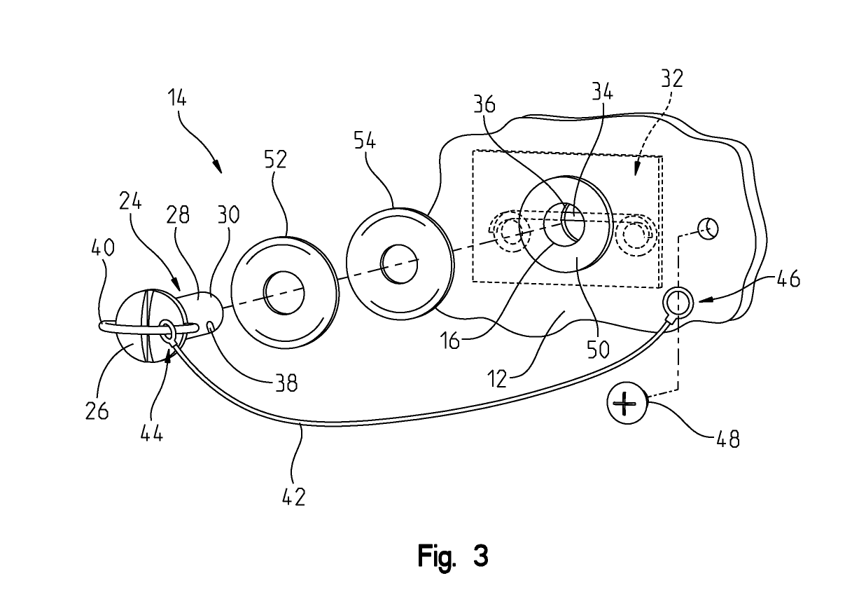

Referring now to FIG. 3, the fastener assembly 14 is again shown in a partial-exploded view from a perspective to illustrate the structural features of the fastener assembly 14. Due to the size of the base portion 26 of the fastening member 24 relative to the interior surface opening 16, and further to facilitate rotation of the fastening member 24, a plate member 52 is disposed around the central portion 28 of the fastening member 24. In the preferred embodiment illustrated in FIGS. 2 and 3, the plate member 52 has an annular shape, such as that of a metal washer. The plate member 52 of the preferred embodiment shown in FIGS. 1-3 is disposed between the base portion 26 and a securing member 54.

The plate member 52 surrounds the central portion 28 with a small clearance between the central portion 28 and the plate member 52 due to the plate member 52 having an inner diameter slightly greater than the diameter of the central portion 28. This creates a non-interference fit between the plate member 52 and the central portion 28. In order to prevent the plate member 52 from sliding off of the fastening member 24 when the fastener assembly 14 is decoupled from the spring plate 32, the securing member 54 is displaced around the central portion 28 in an interference fit relationship with the fastening member 24. The interference fit of the securing member 54 on the central portion 28 is accomplished by sizing the inner diameter of the securing member 54 slightly smaller than the diameter of the central portion 28.

In another embodiment of the present invention, the plate member 52 is not included in the fastener assembly 14, and the securing member 54 serves the function of the plate member while maintaining an interference fit relationship with the fastening member 24 to prevent disconnection from the fastening member 24. In the preferred embodiment, the securing member 54 has an annular shape, such as that of a washer, and is composed of a polymer material, such as polyvinyl chloride or PVC. However, securing members having alternative structures are included in the present invention. Additionally, securing members consisting of other materials, such as an elastomer or metal, are included in the present invention.

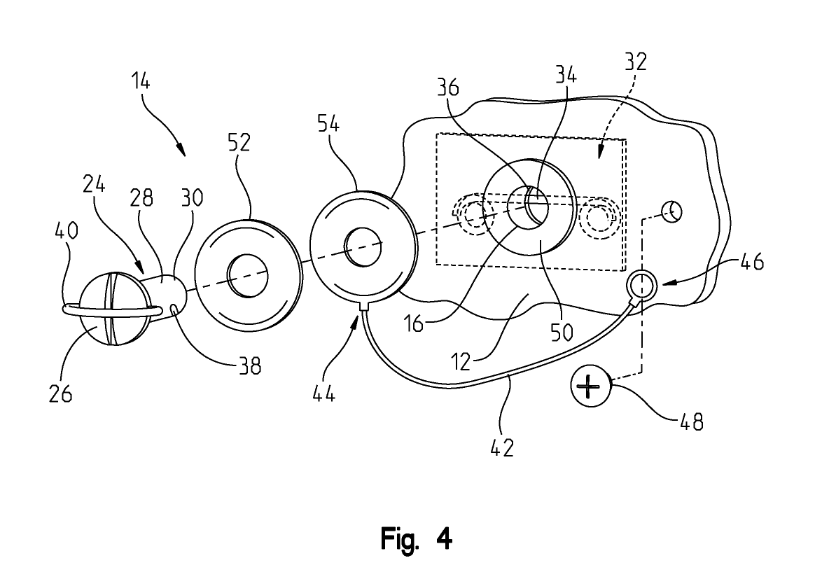

Referring now to FIG. 4, an alternative embodiment of the present invention may include the tether member 42 having its first end 44 directly coupled to, or integrally structured with, the securing member 54. Although the plate member 52 is included in the fastener assembly 14 of FIG. 4, the plate member 52 is not required in this embodiment for the reasons discussed in the previous paragraph. The direct connection of the tether member 42 to the securing member 54 accomplishes the same goal as the preferred embodiment shown in FIGS. 1-3 of retaining all parts of the fastener assembly 14 with the saddlebag 10.

As can be understood from FIGS. 1-4, when the fastener assembly 14 is fastened to the spring plate 32, the fastening member 24 passes at least partially through the anchoring surface of the interior surface 12, and the anchoring surface surrounds the fastening member 24. When the fastener assembly 14 is not fastened to the spring plate 32, the securing member 54 and the tether member 42 cooperate to prevent disconnection of all parts of the fastener assembly 14 from the saddlebag 10. Further, once the fastener assembly 14 and the saddlebag 10 are decoupled from the vehicle, the bumper pads 20 prevent an abutting surface from damaging the lower surface 22 of the saddlebag 10 when the saddlebag 10 is placed on the abutting surface to rest after saddlebag detachment.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A saddlebag attachment assembly, comprising:
a fastener assembly comprising:
a fastening member comprising a base portion and an axially extending central portion adjacent to said base portion; and
a securing member surrounding said central portion and contacting said central portion in an interference fit; and
a tether member comprising a first end coupled to said fastener assembly and a second end coupled to an anchoring surface, wherein said tether member is configured to structurally connect said fastener assembly and said anchoring surface.

2. The saddlebag attachment assembly of claim 1, wherein said securing member is annular.

3. The saddlebag attachment assembly of claim 1, wherein said securing member is composed of a polymer or elastomer material.

4. The saddlebag attachment assembly of claim 1, further comprising a plate member surrounding said central portion and disposed between said base portion and said securing member.

5. The saddlebag attachment assembly of claim 4, wherein said plate member is annular.

6. The saddlebag attachment assembly of claim 1, wherein said fastening member further comprises an attachment portion coupled to said base portion, said tether member being coupled to said fastener assembly via said attachment portion.

7. The saddlebag attachment assembly of claim 6, wherein said attachment portion comprises an annular structure, said tether member being coupled to said attachment portion via said annular structure.

8. The saddlebag attachment assembly of claim 1, wherein said fastening member is configured to fasten by rotation of said fastening member about a longitudinal axis of said fastening member.

9. The saddlebag attachment assembly of claim 1, wherein said first end of said tether member is directly coupled to said securing member of said fastener assembly.

10. The saddlebag attachment assembly of claim 1, wherein a vehicle having a saddlebag comprises said anchoring surface.

11. The saddlebag attachment assembly of claim 10, wherein said saddlebag comprises a plurality of pads configured to be coupled to a lower surface of said saddlebag to prevent contact between the lower surface and a surface upon which the saddlebag rests.

12. A saddlebag removal system, comprising:
a securing member configured to surround a central portion of a fastening member and contact said fastening member in an interference fit; and
a tether member configured to flexibly couple said fastening member to an anchoring surface, wherein said securing member and said tethering member cooperate to maintain a structural connection between all parts of a fastener assembly.

13. The saddlebag removal system of claim 12, wherein said securing member is annular.

14. The saddlebag removal system of claim 12, wherein said securing member is composed of a polymer or elastomer material.

15. The saddlebag removal system of claim 12, wherein said fastener assembly is configured to fasten by rotation of said fastening member about a longitudinal axis of said fastening member.

16. The saddlebag removal system of claim 12, wherein said securing member is configured to be disposed adjacent to a plate member surrounding said central portion in a non-interference fit relationship, said plate member being disposed between said tether member and said securing member.

17. The saddlebag removal system of claim 12, wherein said fastening member is configured to at least partially pass through said anchoring surface upon fastening.

18. The saddlebag removal system of claim 17, wherein said anchoring surface forms one portion of a saddlebag coupled to a vehicle.

19. The saddlebag removal system of claim 18, wherein said vehicle is a motorcycle.

20. The saddlebag removal system of claim 18, wherein said saddlebag comprises a plurality of pads configured to couple to a lower surface of said saddlebag to prevent contact between the lower surface and a surface upon which the saddlebag rests.
